(19) United States
(12) Patent Application Publication
(10) Pub. No.: US 2004/0258281 A1
(43) Pub. Date: Dec. 23, 2004

(54) System and method for preventing identity fraud

(76) Inventors: David Delgrosso, Naperville, IL (US); Fraser Orr, Naperville, IL (US)

Correspondence Address: EDWARD L. BISHOP, 311 S. WACKER DRIVE, 53RD FLOOR, CHICAGO, IL, 60606-6622, US

(21) Appl. No.: 10/837,738

(22) Filed: May 3, 2004

Related U.S. Application Data
(60) Provisional application No. 60/467,168, filed on May 1, 2003.

(51) Int. Cl. G06F 17/60

(52) U.S. Cl. 382/115; 705/64

(57) ABSTRACT

A system and method for verifying the identity of an individual for check cashing and other financial purposes is disclosed. A client, such as a bank or other financial institution, obtains a biometric identifier from a customer and can either try to match it in a local database or send it to a central database to be matched. Either database can be filtered according to a tag or location of the institution to speed up the matching process. The central database transmits information associated with the matched individual to determine whether or not to complete the transaction.

### RELATED APPLICATIONS

This application claims the benefit of U.S. Provisional Patent Application No. 60/467,168, filed on May 1, 2003, and incorporated herein by reference.

### TECHNICAL FIELD

The present invention generally relates to an identification system for preventing fraud and more particularly, to an identification system using biometric data for verifying users and preventing fraudulent check cashing.

### BACKGROUND OF THE INVENTION

Identity fraud has become increasingly common in today's society. As more people advance into the electronic age, it has become easier to digitally manipulate common forms of identification. It is no longer safe to merely require a social security number and a driver's license or other picture identification to verify an individual's true identity. As computers, scanners, and printers improve in quality, so do fraudulent forms of identification. Fraudulent identification has become increasingly sophisticated, with even trained professionals, in some cases, unable to tell the difference between a fake and a real form of identification. Average customer service employees generally have even less training in distinguishing between real identification and fakes.

One area particularly susceptible to fraudulent identification is banking and check cashing systems. Check cashing can be performed for individuals (the payee) that do not have bank accounts if the payor's account is with the bank so the checking information can be verified. In these situations, the bank typically requires some form of photo identification such as a driver's license to verify the individual's identity as well as to record the individual's driver's license number if there is ever a problem with the check. Bank tellers are given brief training for distinguishing between real and fake identification, but they are not generally professionals at such matters. For a reasonable amount of money, an individual can purchase image editing software and a printer capable of creating realistic drivers' licenses and social security cards. These forms of fraudulent identification can be used to mislead tellers and other customer service representatives at banks or other financial institutions.

Additionally, other check cashing institutions cash checks for individuals even though neither the payor nor the payee have an account with the institution. Even though the check is typically verified according to the account number, there is no way to guarantee the check is not stolen or fake. Not only could the check be stolen, but also the individual cashing the check could be using fraudulent identification.

Apart from check cashing, an individual may try to use fraudulent identification to open credit accounts. As with banks, to apply for credit accounts, an individual typically needs a photo form of identification and in some cases, an additional form of identification such as a social security card. As previously noted, both photo identification and social security cards can be easily manipulated using digital editing software and a printer.

Overall, the problems with fraudulent identification originate from the fact that current forms of identification are too prone to manipulation because of advancing technology. To combat evolving digital imaging technology, new security measures are being employed with photo identification such as holograms. While improvements to photo identification may prove helpful, more needs to be done to prevent identity theft and fraudulent identification.

One method to prevent identity theft and fraudulent identification is to use biometric information to identify individuals. Biometric information, such as fingerprints, is a nearly infallible means of personal identification that is not easily falsified. Fingerprints do not change with time and are unique to each individual. However, there remains a need for an efficient system and method for identifying individuals to prevent identity fraud related to banking and credit transactions that is capable of identifying individuals at any location.

### SUMMARY OF THE INVENTION

The present invention relates to a method and a system that can be implemented, at least in part, as a computer program to verify the identity of an individual and monitor activity related to check cashing and credit reporting services.

The present invention helps prevent identity fraud by using biometric identifiers to verify the identity of individuals. The biometric identifier is captured at a remote location and can then be compared to either a local database or sent to a central server for comparison to biometric identifiers contained in a central database. If a match is found in the local database, the client (bank or other user of the system) sends a message to the central server to obtain the information regarding the identified individual. The central server first verifies the local match, but if a match is not found on the local database, or if the local database is not used, the central server tries to match the biometric identifier to verify an individual. If there is a successful match, the central server transmits information contained in data fields to the client regarding the matched individual. One advantage of the present invention is this system contains a large database, not restricted to a local region.

Another advantage of the present invention is that it is capable of being highly efficient when searching either a local or a central database to match a biometric identifier. The local database is smaller and thus faster to search than the central database. But, both of these databases are capable of being searched according to a tag or location. For example, a biometric identifier stored in a database can be tagged by the individual's last name, phone number, date of birth, etc. so that the entire database need not be searched according to the biometric identifier. This improves efficiency by filtering the database into a smaller database to be searched for a matching biometric identifier. Searching according to biometric identifiers is much slower than searching according to a tag or location. The faster tag searching eliminates identifiers not needing to be searched to determine a match, thus decreasing the total search time. Therefore, another advantage of the present invention is the efficiency associated with searching the databases for a matching biometric identifier.

Other advantages and aspects of the present invention will become apparent upon reading the following detailed description and the accompanying drawings.

### BRIEF DESCRIPTION OF THE DRAWING

In the accompanying drawings forming part of the specification, and in which like numerals are employed to designate like parts throughout the same:

FIG. 1 is a simplified block diagram of an embodiment of a system in accordance with the present invention for identifying an individual to prevent check cashing fraud;

FIG. 2 is an embodiment of a map of screens that can be provided to a user (e.g., bank teller) of the system of FIG. 1;

FIG. 3 provides an illustration of an identification page or screen in accordance with the present invention;

FIG. 4 is a map of an embodiment of a finger scanning process in accordance with the present invention;

FIG. 5 provides an illustration of an Office of Foreign Assets Control (OFAC) screen or page in accordance with the present invention;

FIG. 6 is an embodiment of a map of screen that can be provided to a user (e.g., back management, staff, and the like) of the system of FIG. 1;

FIG. 7 provides an illustration of a customer list page or screen in accordance with the present invention;

FIG. 8 provides an illustration of a mark transaction dialog in accordance with the present invention; and,

FIG. 9 is provides an illustration of an edit customer notes dialog in accordance with the present invention.

### DETAILED DESCRIPTION

While this invention is susceptible of embodiments in many different forms, there is shown in the drawings and will herein be described in detail, preferred embodiments of the invention with the understanding the present disclosure is to be considered as an exemplification of the principles of the invention and is not intended to limit the broad aspect of the invention to the embodiments illustrated.

Definitions of Terms

Throughout the specification, the following terminology will be used:

1. Bank—Refers to one type of entity that can use the present invention. However, this invention is useful for many other organizations such as financial institutions, credit bureaus, credit card companies, and retail outlets that cash negotiable instruments, such as checks. Accordingly, these other organizations are included in the term bank for the purpose of this specification.

2. Customer—Refers to a person who wishes to cash a check or otherwise use the present invention to verify his or her identity.

3. Teller—Refers to a representative of the bank who can operate an embodiment of the present invention for assisting a customer in that customer's transaction. This term is also applicable to any other representative that uses an embodiment of the invention to verify a customer's identity.

4. Bank Network Controller—Refers to the person or persons who may be responsible for the operation of an embodiment of the present invention in any particular bank or other organization using the present invention.

5. Biometric identifier—Refers to a unique feature of a customer, such as voice print, palm print, finger print, facial recognition pattern, retinal recognition and so forth.

6. Biometric reader—Refers to any device for collecting biometric identifier data.

Overview of the System

The present invention can be implemented by any form of applicable technology, including but not limited to the following computer and circuitry types: electrical, digital, analog, optical, magnetic, mechanical, or any combination thereof. In addition, the system chosen to implement the invention can be general purpose, embedded, portable, networked, client/server, web server, database server, wireless or any combination thereof. In addition, user input can be obtained through various means including but not limited to keyboard, computer mouse, punch cards and speech recognition. Biometric input can be obtained through various means including, but not limited to fingerprint scanners, retinal scanners, voice scanners, video cameras, microphones, or any other scanners. Output devices include, but are not limited to cathode ray tube, light emitting diode, liquid crystal display, vacuum, fluorescent or plasma displays, speech synthesis, printers and plotters.

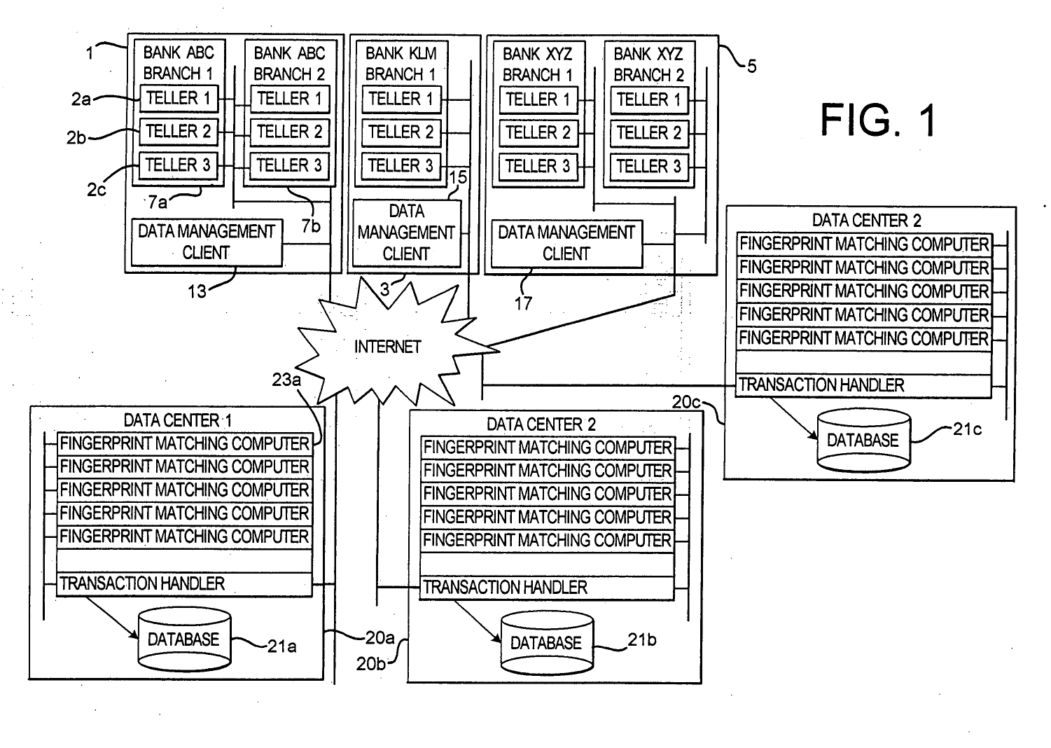

Referring to FIG. 1, an embodiment in accordance with the present invention is shown. Three independent banks are represented as 1, 3, and 5. Bank 1 has multiple branches 7a, 7b associated with it. Any number of different branches and banks can use the present invention. Additionally, any number of teller stations can be located within each branch. For example, branch 7a has three teller stations 2a-c. Each bank 1, 3, 5 can have a data management client 13, 15, 17 respectively. The data management client can be used by an authorized representative of the bank to add data about individuals or transactions. Each teller station 2a-c is connected by an internal network to an external network and a central server (data center), although multiple central servers 20a-20c can be used to improve efficiency.

Each central server 20a-c has a copy of the central database 21a-c. The copies of the central database are identical. Each central database 21a-c contains biometric identifiers and associated identities with data fields about the individual corresponding to the identity of that individual.

An individual desiring to cash a check inputs at least one biometric identifier at a teller station such as teller 2a at branch 7a of bank 1. The biometric identifier is transmitted through the network to a central server 20a for analysis. The central server 20a searches its copy of the central database 21a for a matching biometric identifier. This can be accomplished using a single computer 23a or divided between many computers for improved efficiency. If the identifier is similar to multiple biometric files, the system will request and match an additional identifier to verify the identity. Once a match has been made, the corresponding identity and data fields are transmitted back to the teller station 2a for approval to finalize the check cashing transaction.

Bank Tellers

Each bank teller station has a computer running client computer software that implements an embodiment in accordance with the present invention. This client software provides a graphical user interface (GUI) both to capture information from the customer, which is sent to the central servers, and to display information returned from the central servers. The computer which runs the client software also has a biometric reader attached to it, usually through a universal serial bus (USB) port, though other connectivity modalities can be available depending on the particulars of the capture device. Optionally, the client software can also have a check scanner attached that reads the magnetic numbers at the bottom of a check. The present invention can also include a software development kit. There is a plethora of biometric reader devices manufactured by various corporations and it would be cumbersome to develop software for each reader. The software development kit incorporates many other reader software development kits into one so the system software can be developed independent of the devices.

During a transaction, the client software captures information about the customer, including a biometric identifier, and optionally captures information about the check itself. This information is sent to the central servers. The particular central server that the teller station uses is dynamically reconfigurable from the central servers. This allows the flexibility to effectively balance the load on the biometric identifier matching engines.

Transmission Protocol

When the data is sent from the client software to the central servers, it is sent using a protocol. The data is packaged up according to this protocol, and encrypted using a public key cryptographic system. This protocol can be replaced with a different encryption protocol if desired. In public key cryptography, a pair of keys, which are mathematically related, is generated. One of these keys, the public key, can be used to encrypt a message, but not decrypt it, whereas the other, the private key, can be used to decrypt the message, but not encrypt it. The public key is not secret since it cannot be used to decrypt the message.

In this system, each teller station has its own public and a private key. The public key for each teller station is known to the central server, and that key is used to encrypt each message sent from the central server to the teller station. When it is received, the teller can use its private key to decrypt the message.

Additionally, for each teller station, the central server has a public and a private key. That is to say, the central server has many public/private key pairs, one for each teller station. Whenever a teller station wishes to send a message to the central server, it encrypts it with the specific central server public key allocated to that teller station. When the central server receives the message, it is decrypted by the corresponding private key. This multiple use of asymmetric public key cryptography greatly increases the security of the system by making key distribution secure. Additionally, even if one encryption key was broken, the system is not compromised because only one client key was decrypted, leaving the remaining system secure.

The communication protocol provides for the following functions:

1. Identify this person—Requests the person whose biometric identifier is provided in the protocol be identified, and information about that person be returned. This protocol goes from client to server.

2. Enroll this person—Requests the person who's biometric identifier is included in the protocol be enrolled in the system. This protocol travels from client to server.

3. Request received—This informs the client that the central server has received the request and is beginning to process it. This protocol goes from server to client.

4. Request reroute—This corresponds to the request received protocol, but it informs the client that subsequent requests should be sent to a different central server and also includes the IP address of the new central server in the protocol., This protocol goes from server to client.

5. Identification result—Returns the result of an identification request containing all the information that the specific bank is privy to. This protocol goes from server to client.

6. Enroll successful—Returns an indication that the enrollment was successful. This protocol goes from server to client.

7. Duplicate enrollment—Returns a result very similar to Identification result, except it is returned in response to an enrollment request (Enroll this person), but the enrollment failed due to duplication. This protocol is sent from server to client.

8. Adjust data—This protocol is sent from a data manager station at a bank to adjust some fields in the central database concerning a particular individual. This protocol is sent from the data management client to the server.

9. Adjustment result—Returns an indication of the success or failure of an Adjust data request. This protocol is sent from the server to the data management client.

10. Download new client GUI—A process whereby the data management software downloads GUI details to the front-end software. This is a process to allow the bank managers to change how the teller screen looks and automatically download that new look and feel. This protocol is sent from the server to the client.

11. Send me a local database image file—A process whereby the local machine can download a local database for biometric data searching. By doing some of the searching locally it greatly reduces the load on the central servers. The central server determines which biometric data to put in the database. The local database is a set of biometric data, and an associated customer identifier. This protocol is sent from the client to the server.

12. Local Database Message—This message is in response to “Send me a local database image file.” It contains the requested local database of biometric data for searching. The client machine should cache the local database in a local encrypted file until the server indicates that a new local database is required. This protocol goes from the server to the client.

13. Person identified—This indicates the local database has successfully identified the individual in question and requests that the central server fill in the remaining data fields for that person such as name, address, transaction log, etc. The server responds with a standard identification result message. However, the identification message result can be preceded by “Update local database.” This protocol goes from the client to the server.

14. Update local database—This message is sent when a “Person identified” message indicates that the local database is significantly out of date. It contains a list of instructions to add, remove or change biometric data in the local database. It can also contain a single flag indicating that the database is too far out of date and that a new local database should be requested. This message goes from the server to the client.

15. Request local database encryption key—The local database is stored on the local disk in an encrypted fashion. This protocol requests the encryption key, which is stored only on the central servers. This protocol goes from client to server.

16. Local database encryption key reply—This message is in response to the previous message and contains a reply containing the local database encryption key. This message goes from server to client.

Central Server (Data Center)

The central servers are responsible for processing requests from the clients. Each central server has the following responsibilities and functions:

1. Biometric matching—A set of computers is used to match a biometric profile sent from the client to one of the stored biometric files in the database.

2. Database operations—A database performs a number of different functions, such as finding data about a customer when the customer's fingerprint is matched; enrolling data about a customer when the customer's biometric identifier is not matched during an enrollment; performing transaction detail based analysis of a transaction, such as looking for bad checks, stolen check stock, and terminated employees; modifying a person's record in accordance with the user request or from the data management client software; determining information a bank is entitled to view; managing the downloading of new GUI front ends to the tellers; determining the central server associated with each teller station; and logging information.

3. Legacy check verification—Banks maintain records of checks that are fraudulent. These checks can be scanned into the system and the information can be used to mark existing individuals and new enrollments that have previously committed check fraud at other banking institutions.

4. Logging operations—This function is closely related to database functions. However, it is considered separately since it has a fundamentally different character. This process logs every transaction request and response. It is designed so that any transaction can be accurately redisplayed, including all the detail transmitted to the teller. Additionally, this process is responsible for storing graphical images of every biometric file sent through the system. The log can also be printed.

5. Validation of drivers' license numbers—This function verifies each individual's driver's license number.

6. Validation of social security numbers—This function verifies each individual's social security number.

7. Compliance with OFAC regulations—This function assists in ensuring that the individual is not a Special Designated foreign national.

Data Management Client

The data management client enables the managers of each bank to input information about bad checks and other commentary on individuals and transactions. It allows the following actions:

1. Annotate an individual who enrolled at the bank—Permits a manager to categorize an individual with a comment and a seriousness comment, levels one through ten. Depending on the severity of the comment level, the comment will be displayed more and more aggressively to the teller when this person is accessed.

2. Annotate an individual transaction performed at this bank—This allows the manager to annotate a particular transaction even if the individual was not enrolled at the bank. This might arise should someone enrolled elsewhere cash a bad check at a different bank.

3. Delete an individual enrolled at the bank—This is a process which allows an individual to be deleted from the system should he or she be enrolled at that bank.

4. Viewing transaction logs—Allows the system to view transaction logs in a variety of ways, including by branch, by teller, by company, by account and by person. It also allows filtering by company and amount.

5. Configure a bank's sharing parameters and various other configuration details—Each bank can designate which fields it shares out of its portion of the database. Preferably, this must be done in cooperation with the central server. The user of the data management software can use it to make requests to the central server, however, the final installation is preferably done at the central server headquarters after discussion with appropriate authorities at the bank.

6. Add or delete extra fields collected on each user and transaction—The user of the data management software can use it to make requests to the central server, but the final installation is preferably done at the central server headquarters after discussion with appropriate authorities at the bank.

7. Set up a new GUI front end for the banks—The user of the data management software can use it to make requests to the central server, however, the final installation will preferably be done at the central server headquarters after discussion with appropriate authorities at the bank.

Personal and Transaction Database

Each individual bank has the ability to configure its portion of the database in a manner consistent with its particular policies. The database makes two areas available to the banks: personal data, which contains information about an individual with a particular biometric identifier; and, transaction data, which contains information about the transactions an individual has performed. Each area contains a number of fields of data about the person or transaction. For example, personal data contains the name in one field, the address in a different field and so forth. Each bank can choose which fields it wants to share and which it wants to keep private. Additionally, each bank can also add custom fields of its own to either set of data. For example, a specific bank can want to collect a customer's height, and eye color as an additional identification criteria. This bank can legitimately add that field, and either share it with other banks or not share it.

When a bank opts to share a particular field, it makes that bank's data on that field available to all others who are also sharing the same field. Thus, sharing the field also gives one access to that data from other banks. If one does not share a field, one cannot view other bank's information in that field. Additionally, a bank can choose not to include a particular field in its database. In such case, that field is left blank. However, it is preferred that both areas have some fields that are mandatory and must be included and shared. Examples of these fields are listed below in Table 1.

In one embodiment, the required fields that preferably must be shared for each individual are: name (title, first, middle initial, last, suffix), address, date of birth, gender, social security number and driver's license number or alternative identification. The required fields that preferably must be shared for each transaction include the last name, the first name and the amount of the transaction.

TABLE 1
Possible mandatory fields.

| | |
|---|---|
| Name | Address |
| Biometric data | Enrolling Bank |
| Date of enrollment | Driver's license number |
| Comments | Payee |
| Payor | Account number |
| Check number | Date of transaction |
| Transaction number | RTN number |
| Check stock number | Teller system field code |

Biometric Database

Image Files Verses Biometric Codes

The following description discloses an embodiment of the present invention using fingerprints to identify individuals. Other forms of biometric data can also be similarly used.

Generally speaking, it is impractical to compare the specific images of two fingerprints to determine similarity or identity. There are several reasons this is true, but the principle reason is that such a comparison would be extraordinarily slow. Consequently, before a comparison is made, a feature extraction algorithm is run on the fingerprints to identify crucial points of comparison. Specifically, fingerprint algorithms find certain points of ridge bifurcation and end points, and use their positions and the angles of the ridge as a biometric code describing the fingerprint. Each individual fingerprint has a set of these so-called “minutiae points,” and all fingerprint comparisons take place by comparing these sets of biometric code in particular ways. Such codes allow the fingerprint algorithms to more easily compensate for the major problems in comparing images, namely the translation, and rotation of the two images, in addition to the elasticity of the skin in the finger causing other types of distortion.

Finally, biometric codes can largely ignore spots, scars and other blemishes. These biocodes can be readily generated from a fingerprint image. However, the reverse process, converting a biocode into a fingerprint image, is not possible. It is necessary therefore, if it is desired to reproduce the exact fingerprint, to store both the biocode and the fingerprint image. Biocodes are typically a few hundred bytes in length, a size which can readily be stored in a database. However, images/files are several dozens of kilobytes, which preferably must be stored in separate files. It should be noted that the above principles similarly apply to other types of biometric identifiers, including facial recognition, retinal recognition and voice scan.

Image File Storage

Each fingerprint image is stored in a separate file. An image of every fingerprint read by the system is stored, including enrollments and authorizations. This enables the system to recreate any transaction in detail. Each fingerprint image is stored under a file name with a numeric code corresponding to its 64-bit identifier in the database. The fingerprints are stored in a “tree-like” data structure in the file system where the file path to the picture corresponds to the file name. Each file is stored in standard jpeg format.

Database History and Purging

To reduce the amount of searching required on fingerprint records, the records are regularly purged. All personal records free of negative comments that have not been accessed in the previous year are removed, along with all attached transaction records. This process is performed overnight while the database load is very low.

Biometric Searching Technologies

Exhaustive Searching

Whenever searching a database of biometric identifiers, two results are possible, either the identifier is found, or it is not found. Both these results are useful under different circumstances. For example, when trying to identify an individual based on a fingerprint, it is obviously necessary to find a matching fingerprint in the database. However, it is also useful to know that there is no match. For example, when enrolling a new user, it is useful to know that the individual's fingerprint is not enrolled anywhere else in the database to guarantee unique enrollment. Consequently, the present invention has two important processes: searching for a match, and determining that there is no match. The most straightforward way to perform both of these processes is by exhaustively comparing every fingerprint in the database with the scanned fingerprint. But this can be very expensive. One goal of the present invention is to reduce exhaustive searching as much as possible. This is accomplished by organizing the order in which the fingerprints are searched in such a way that the system is more likely to encounter a matching fingerprint first. The following description outlines approaches to accomplish this goal.

Parallel Searching

Whenever a biometric identifier is received into a central server and slated for identification by exhaustive search, it is submitted to several searching computers at once. The complete database of biometric identifiers is divided up equally among the searching machines. The size of the database searched by each machine depends on the performance of that machine.

When an exhaustive search is made, the same biometric identifier is submitted to all the searching machines simultaneously, and they all search their databases in parallel. When one search engine matches it signals that a match is found, searching on all other machines for that biometric identifier stop.

Depending on load considerations and on the number of transactions per second, computing resources can be allocated appropriately. The database splits into fractions, called fl-fn. When the number of transactions is low, each fraction sits on one searching computer. However, should the number of transactions justify, fractions can be placed on several computers at once. This means that not only can the system allow one biometric identifier to be searched for on multiple machines at once, but one can also have multiple fingerprints searched on multiple machines simultaneously.

Geographic Fractional Searching

Geographical fractional searching is useful for eliminating excessive use of the central server based on the observation that most likely a biometric identifier is going to be used near the place where it is enrolled. This is a straightforward observation because people generally tend to stay in the same location for long periods of time. Consequently, if the fingerprints in the database are sorted by the zip code where individuals get registered, then the system can search according to the zip code where the fingerprint is obtained, thus, the system is more likely to find a match quickly.

However, a zip code is generally too exact a value, since individuals regularly travel outside their zip code area, but still remain nearby. Consequently, a faster search based on the surrounding zip codes can be performed. One embodiment sorts identifiers according to the first three digits of the zip code where the identifier was enrolled. What this means is that when searching for a biometric identifier, the system first looks at all the biometric identifiers enrolled in nearby zip codes as the location where the biometric identifier was obtained, to find a match. This heuristic works well in both types of search. If the system is searching to match a biometric identifier, it will most likely find a match early on. However, if the system is performing a search to determine that there is no match, it will most likely hit on the erroneous match early in the searching process. This expedient reduces the cost of searching a database of fingerprints.

Tagged Searching

In tagged searching, an additional tag can be used to further reduce the number of biometric identifiers to be searched. But tagged searching is only useful for finding a matching biometric identifier; it is not useful for determining there is no match. A tag can be something easily entered into the system, such as an encoded last name, a birth date or a phone number. When using a last name as a tag, it has been found that a fuzzy matching system such as Soundex or Metaphone provides an ideal tag. It has been determined through experimentation that such an encoding can reduce the number of biometric identifiers searched. On average, such searching requires one five hundredth of the number required otherwise, with a relatively flat peak behavior on extremely common last names.

The process involves tagging every biometric identifier with a code indicating the Metaphone encoded last name of that biometric identifier's owner, and comparing the tag against the last name before the biometric identifier comparison is made. It is much less expensive, in terms of performance, to compare the encoded last name than to compare the biometric identifier itself. It is estimated to be ten thousand times quicker, depending on the specifics of the implementation. Consequently, this is a valuable tool to reduce the cost of searching.

Tagged searching is also useful for quickly identifying duplicates when an individual is attempting to enroll in the system. When searching for a duplicate enrollment, the system performs a preliminary search to find any duplicates based on a tag because this method is much faster. If no duplicate is found, the system continues to perform an exhaustive search for the biometric identifier to determine if a duplicate exists.

However, this process of tagged searching has two major problems. First, it requires extra data entry, requiring the teller to enter the last name of the person along with his or her biometric identifier. Second, it only works if the last name supplied is the same as the one in the database. Should a false name be given, that biometric identifier will not be matched. In general, this can be acceptable if one is trying to identify the person, since a failed identification match requires an enrollment. The enrollment process finds the already enrolled biometric identifier because the system performs an exhaustive search to verify that the biometric identifier does not already exist in the system.

Localized Searching for Load Distribution

A third heuristic of the present invention to reduce the load on the biometric identifier database is to do some of the searching on the local computers. In particular, the system can download a part of the biometric identifier database onto the teller station computer. The teller station computer then searches this part of the database for a matching biometric identifier. If the search matches an identifier, then the client sends a protocol message to the central server to obtain the details of the matched person. Otherwise the client asks the central server to perform a full search. If the teller station matches an identifier, the central server will still match the identifier contained in its database to the suggested match to verify the individual and protect the security of the system. This process allows the system to offload some of the processing of biometric identifiers onto the client's machines, which greatly reduces the amount of processing the central server performs.

The protocol for this is straightforward. On initialization, the teller machine sends a message to the central server requesting the local database. The central server algorithms decide which are the best biometric identifiers to send. The easiest algorithm is to send the biometric identifiers matching and surrounding the teller station's zip code. This data is stored in an encrypted file on the teller machine and also held in the machine's memory. When a search is commenced, the teller station performs the search, and when a match is found, the client machine sends the result of that match to the central server. Again, the central server compares the proposed match with the identifier contained in its database to verify the individual. If a match is not found, then a standard search is performed using the central server rather than the local machine.

When a local search is performed, the local machine also sends a date and time code back to the central server. This date and time code reflects the last time the local database was updated. If the local database is older than a predetermined date, the central server sends a protocol message containing information that the local machine can use to update its local database. This information is applied to the memory search image, and then saved in encrypted format into a file on the local machine's hard drive. This information consists of adding new fingerprints, deleting old ones and changing existing ones. The encryption key for the local file is stored at the central server, not on the local machine. The encryption key is provided over an encrypted channel when the teller station requests it and it is never saved anywhere on the local machine. This prevents the proprietary database information from becoming exposed if a hacker were to gain access to the local machine.

When the client software is first installed, it requests a local database from the central server according to its home zip code for use in localized searching. The client software first performs a test to determine if the local machine is capable of performing local client searching. A database is transferred to the local machine and is stored as a cached file on the local hard drive. Subsequently, whenever the client software is run, it determines the encryption key of the local cached database by requesting the local database encryption key from the central server. This key is used to decrypt the cached file in the machine's memory. Whenever an identification is requested by the software, it first searches for the biometric identifier in its local database. If it is found, then a request for the information, the biometric identifier and corresponding identification number, are passed to the central server. The central server verifies the biometric identifier matches the identity proposed by the client. Additionally, this message contains the date and time that the local biometric identifier database was last updated.

The server looks at the date the biometric identifier database was last updated, and if necessary, sends a list of changes the local database must preferably make. Alternatively, the server can send a message indicating that too many changes have taken place and a new local database should be downloaded. Next, the server verifies the proposed identity from the client with the biometric identifier contained in the database. Finally, the server sends a standard identification message giving the client software a full set of information about the customer. If the local machine cannot identify the customer from its database, the local machine sends a standard identification request to the central server, as if the local database had never been consulted.

Automatic Load Balancing

The central servers constantly monitor their loads and response time, and identify central servers and computer systems that are overloaded. Using a dynamic balancing algorithm, the system reallocates some of the tellers to different central servers to compensate for this problem.

Enrollment Propagation

In a multiple central server environment, it is desired to keep all central servers up to date with new enrollments. To do so, the central server receiving the enrollment request sends a message to each central server indicating an enrollment of that fingerprint is taking place. Whenever one of the other central servers receives such a message, it is stored on a list of pending enrollments. Whenever a central server performs an enrollment, it first matches against the pending enrollment list. If a match is found, the enrollment is delayed until the original enrollment is complete. When the original enrollment is complete, the central server stores the information in the database, passes the new biometric identifier and corresponding personal information to the other central server to store in their memory databases of biometric identifiers. Finally, the biometric identifier is removed from the pending enrollment list. Subsequently, the delayed enrollment will be allowed, and the duplicate will be found and dealt with in the normal manner.

Biometric Identifiers Obtained in the Enrollment Process

Preferably, when an individual seeks to enroll in the system, at least two biometric identifiers are obtained. One acts as a primary identifier and the other as a secondary or backup identifier. For example, in an embodiment of the present invention utilizing fingerprints, two fingerprints would be obtained. The reason for this is because there is a limit to the degree that two fingerprints can be distinguished when they are very similar. When the individual attempts to enroll, the system performs a search to verify that the individual is not already enrolled. If the central server finds a match or very similar fingerprints, the system automatically notes that those individuals must preferably also provide an additional fingerprint to verify his correct identity for each transaction because they are potentially duplicates.

At enrollment, the present invention also automatically requests identifiers according to a predetermined priority. For example, in an embodiment utilizing fingerprints as identifiers, the system automatically requests certain fingerprints from the individual. If the individual is missing any of the requested fingers, the system proceeds down the list of priority identifiers. The list of priority for the primary identifier follows in order (fingers): right index, left index, right middle, left middle, right ring, left ring, right pinkie, left pinkie, and finally left thumb. The list of priority for the secondary identifier follows in order (fingers): right thumb, left index, right middle, left middle, right ring, left ring, right pinkie, left pinkie, and finally left thumb. If the first available finger on the secondary list is already being used as a substitute for the primary identifier, then the next on the list will be used as a substitute for the secondary identifier.

Overview of the Search Process

In an embodiment, an overview of the steps in the searching process is as follows:

1. A biometric identifier is searched in the local database (optionally).

2. If a match is found, the central server verifies the proposed match from the local database with the identifier contained in the central database.

3. If a match is not found, the biometric identifier is sent to the central server.

4. If the biometric identifier is tagged, it is initially searched according to the tag.

5. If the biometric identifier is not tagged, it is searched according to Zip code geographical fractioning.

6. If geographical fractioning fails then the, biometric identifier is searched for exhaustively.

Once the biometric identifier is identified, the database is used to decorate this biometric identifier with all data relating to that person, and also all recent transaction data performed by the person viewable by the bank. Any of the above steps except step 6 can safely be removed without affecting the outcome of the search, though obviously impacting the performance of the central servers.

Biometric Identifier Identification Tasks

1. Enrollment—This is a process whereby a person who is not associated with the database can enroll his or her biometric identifier in the database for future check cashing processes. Preferably, every person using the system must first enroll in the system.

2. Fraud Check—This is a process whereby a person can identify himself or herself using a biometric identifier to verify that he or she has used the system without fraud. Banks can use this information as a basis to decide whether or not to cash a check.

3. Off line enrollment—This process is similar to regular enrollment, but it is performed outside of the bank at the human resource departments of the companies whose employees wish to cash checks.

Information Displayed

The software displays a person's identity such as his or her name, address, and a number of other fields specified by the bank. The system can optionally display a photograph of the person. The system also displays any messages attached to this person including any messages attached to transactions they performed. This allows the system managers to alert the teller of problem customers. The system manager can also display alert messages such as pop up windows that list specific urgent issues with particular customers. The system also lists any recent transactions this person has had with the system, allowing the teller to see when a person is cashing several checks at several different banks, a situation that usually indicates a fraud in progress.

Check Verification Tasks

Stock Number—The database keeps a list of stolen check stock numbers. Every check is compared to the list of stolen check stock numbers.

Check Number—The database keeps a list of stolen check numbers. Every check is compared to the list of stolen check numbers for the specific account the check is drawn against.

Stop Limit—The database can set a limit on the size of checks that can be cashed on a particular account.

Ex-employee alert—The database alerts the teller when someone who has been fired from a company is trying to cash a payroll check after his or her termination. Facilities are provided to allow the cashing of the final paycheck.

Sharing and Updates

Sharing information—One of the features of the present invention is the ability of banks to share their fraud information with other banks. This is largely configurable, allowing each bank to decide on a field by field basis which information to share. A bank can receive information from any data field that it shares with the other banks.

Reconfiguration of the data stored—In addition to certain standard fields, the banks can, at their discretion, collect other types of data from the teller station. For example, a bank might wish to collect an individual's height and/or weight at the time of enrollment.

Downloading of front ends—To facilitate the use of the present invention, the bank can redesign the GUI screens that the teller views. The present invention processes these files and automatically download them to the teller stations.

Analysis and Reporting

Additional unique aspects of the present invention include analysis and reporting functions. Individual banks are allowed to manipulate and interact with their data through a network connection that allows them to generate a number of different reports. For example, each bank or branch can request non-customer transaction reporting. This information can include the number of non-customer transactions, the monetary value of non-customer transactions, and the number of fraudulent non-customer transactions at a bank's various branches. Another aspect of the analysis and reporting functions allows a bank to determine the identity of non-customer individuals that cash checks at their locations and track the types of transactions conducted. This information can be utilized for fraud protection and to market different products to customers and non-customers. The analysis and reporting functions can also be utilized to develop trends for customers, bank branches, and tellers. For example, a trend analysis can be run for each teller to determine if any tellers might possibly be involved with fraudulent transactions. Another example allows a bank to inquire about the volume of transactions during various timeframes to add additional tellers to assist customers. Additional analyses can be performed to meet the specific needs of each bank or branch.

### EXAMPLE 1

Enrolled Customer Wants to Cash a Check

An enrolled user enters a bank, and tries to cash a check. An embodiment of the present invention proceeds through the following steps. The individual's name, right index finger and right thumb, if required, are collected by the teller and entered into the client software. Optionally, the check is also scanned using a check scanner, or the check data is entered by hand. This information is packaged up, encrypted and sent to a designated central server. The information is received by the central server, is unpackaged, and decrypted. The central server uses various algorithms to identify the person with the given fingerprint. Having identified the person, his or her information is looked up in a database, including personal information, and check transaction information. This information is packaged up, encrypted and returned to the same teller station. The information is decrypted and displayed on the screen for the teller. The information is also logged by the central server.

### EXAMPLE 2

An Unenrolled Customer Wants to Cash a Check

In this scenario, a person wishes to cash a check, however, they are not currently enrolled in the system. The person approaches the teller, the teller questions the individual and determines that they are not enrolled. Then the teller clicks the enroll button on their software. The enroll process is used to capture various basic pieces of information, such as name, address and so forth. The enroll process captures several copies of the individual's right index fingerprint or next available primary substitute. Next, the process captures several copies of the individual's right thumbprint or next available secondary substitute. The biometric and personal information is packaged up, encrypted and sent to a designated central server. The information is received at the central server, unpackaged, and decrypted. The central server uses various algorithms to search, comprehensively, for a matching primary fingerprint in the database. If a similar primary fingerprint is found, the secondary fingerprint of each identity is compared to verify if they are duplicates or just similar. The purpose of this search is to eliminate dual enrollments. If no match is found, the data is entered into the database and the new fingerprint is distributed to the various central servers. A confirmation is packaged, encrypted and returned to the teller station. Additionally, the event is noted in the log. If a fingerprint match is found during the search, a message indicating a duplicate enrollment is packaged, encrypted and returned to the teller station. Additionally, the event is noted in the log. The teller station receives the message, unpacks it, decrypts it and displays the information on the screen. All logged information can be printed at any time.

The present invention can be used for increased security for check cashing transactions at banks as well as at many other financial institutions such as credit bureaus. The present invention uses a central server and central database to ensure that an enrolled individual can cash checks or perform other transactions at any bank connected to the central server. The present invention is not limited to branches of an individual bank, but can be used by any and all banks connected to the system. Whatever data fields a particular bank shares can be accessible to that bank about individuals that were not enrolled at that bank. This sharing of information makes the present invention extremely useful for preventing check cashing fraud because an individual's banking history can be available to other banks. The individual's history with other banks can provide insight to his or her propensity to commit fraudulent transactions.

Not only is the present invention useful to many separate banks, but it also operates efficiently. Optional tagging can be used to increase the speed at which biometric identifiers are matched in the system. Additionally, local databases not only improve that speed of biometric identifier matching, but also reduce the load on the central servers.

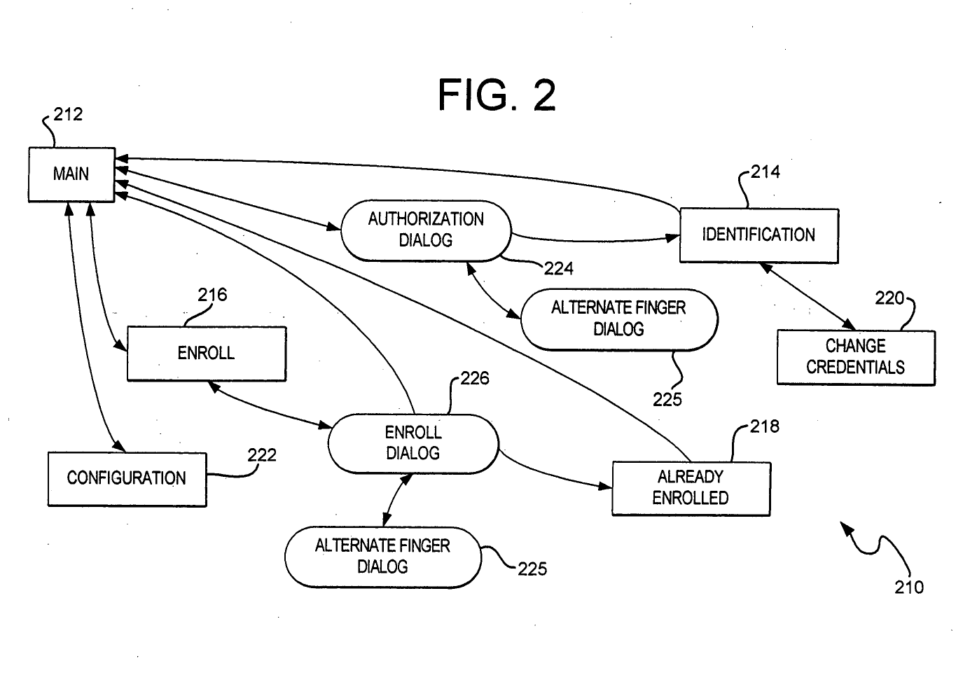

Turning to FIG. 2, a map of screens is provided wherein each screen can be provided on a visual display associated with one or more users of the system (i.e., bank tellers). The screens 210 include a main screen or page 212, an identification screen or page 214, an enroll screen or page 216, an already enrolled screen or page 218, a change credentials screen or page 220, and a configuration screen or page 224.

In an embodiment, the main page 212 is the entry point for the system and is displayed when the program first starts. From this page the teller can reach all other functions. Inputs on this page can include a name input box for entering a customer's name (e.g., first, last, middle initial, and suffix) and a dollar amount for the check being presented by the customer to the teller.

The main page 212 can also include command icons or buttons (not shown) wherein, by selecting an icon, commands are executed such as OFAC, Identify, Enroll, and Exit. The OFAC command causes the system to perform an OFAC check on the customer's name as entered in the main page. In an embodiment, the OFAC check is an exact match comparison against a U.S. Treasury OFAC list. If a match is found, the OFAC match dialog box is show, if no match is found, a message saying so is shown.

The Identify command on the main page 212 causes a request that a person be identified, and a check associated with that person be cashed. As a result, an authorization dialog box 224 is displayed to collect a fingerprint. Using the fingerprint and the last name of the person, the system attempts to identify the person. Should the name and fingerprint match one enrolled in the system database, the identification page 214 for that person is displayed. If the person is not identified, then the user (e.g. bank teller) is informed of this and offered two choices: 1) either click OK or Cancel to terminate the operation, wherein the input fields are cleared and the main page 212 is displayed again; or 2) attempt to enroll this person in the database, wherein the enroll page 216 is displayed with the name from the name input box is pre-filled into that page's form.

In an embodiment, the failure to identify the person using the Identify command does not mean that the person is not enrolled; instead, it simply means that they are not enrolled under the last name given in the name input box. Should a person be enrolled under a false name, they would not be correctly identified at this stage. However, should they subsequently try to enroll, their possible mendacity will be discovered, since the enroll process checks all fingerprints in the database, regardless of which name is used.

The Enroll command on the main page 212 results in the enroll page 216 being displayed. Further, the Exit command causes the software to exit.

Turning to the identification page 214, this screen shows information about a person such as enrollment information and recent transactions. If the customer is submitting a check for cashing, the information about this check is also displayed. The identification page 214 allows the user to indicate the disposition of that check comprising the choices of: accepted, rejected or abandoned. Preferably, a user may not use the file exit command from this page, or close the identification page in any other way, since that would leave a transaction without a disposition.

In an embodiment, any transactions performed by the identified person that satisfied the following criteria are shown on the identification screen 214: 1) all transactions performed in a defined time range such as the past 30 days; 2) all transactions that have been marked in the back office; 3) all rejected and abandoned transactions; 4) all duplicate enrolls (including re-enrolls); and, 5) all enrolls.

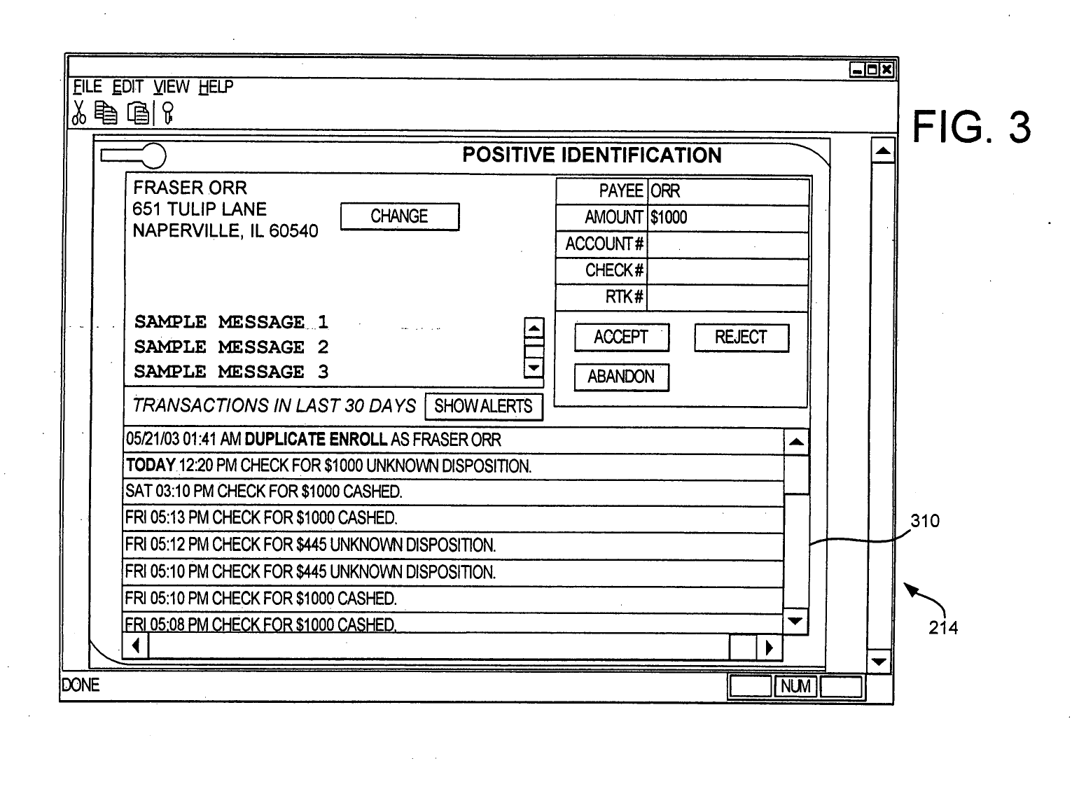

Turning to FIG. 3, preferably all transactions that have been marked in the back office, all rejects, and all duplicate enrolls (excluding re-enrolls) are displayed first in a transaction list 310 provided on the identification page 214, wherein the most recent transaction is displayed at the top of the list. Additionally, all transactions of that nature are further highlighted by having a background color such as, for example, light gray.

After that, all other transactions are shown on the list 310 with the most recent first. The last entry in the list is preferably the initial enrollment of the person. Each transaction lists the date on which it took place, the time, the bank's name and the name of the location, the amount of the check, the disposition of the check, and, if desired, any additional notes.

Enrollment transaction summaries are shown as successful enrollments, duplicate enrollments, and re-enrollments. A successful enrollment transaction summary provides the date and time of the enrollments, along with the full name under which the person enrolled. A duplicate enrollment transaction summary provides the date of the duplicate enrollment, the full name under which the person used when attempting a duplicate enrollment, and the words “DUPLICATE ENROLL” highlighted in red. A re-enrollment is defined as an attempt to re-enroll in the system using the same name or social security number. This is considered a re-enrollment since it is unlikely that the person is attempting fraud, rather they are simply trying to re-enroll and had forgotten that they were enrolled. These types of transactions preferably do not appear at the start of the list 310 and are not highlighted since they are not considered important indications of fraud. A re-enrollment transaction summary provides the date and full name under which the person used when attempting a duplicate enroll.

The identification page 214 also shows the name and address of the person trying to cash the check, and the details known about the check. As stated previously, the bank can enter notes about a person using the back office software as described in detail further herein. Preferably, notes are not shared among banks. In an embodiment, there are three types of notes: 1) regular notes that appear in the area below the person's name; 2) pop up notes that appear below the person's name, but also are displayed in a pop up box when the page is first displayed, and also when the show alerts button or icon is selected; and, 3) cancelable pop up notes, that are displayed the same as regular pop up notes, however, they also have a cancel button or icon on the pop up box. When the cancel button is selected, and a confirmation is accepted from the teller, then that note is permanently cancelled for that user (i.e., teller).

In an embodiment, the identification page 214 can be reached without submitting a check by performing an identify from the main page 212 with the check amount filed left blank. If this occurs, a number of differences appear in the visual display of the identification page 214. In particular, the check information is left blank, the three buttons or icons for accepting, rejecting and abandoning the check disappear, and a new OK button appears in the middle of the area where the accept, reject and abandon buttons are shown on a regular identification screen or page 214 shown in FIG. 3.

The command icons or buttons available on the identification page 214 include: Show Alerts; Change; Accept; Reject; Abandon; OK; and Close. The Show Alerts command causes the pop up box that was originally displayed when the identification page appeared to be redisplayed. The Change command causes the change credentials page 220 to be displayed with the fields filled-in for this person. After the OK icon or button is selected, the same identification page 214 is redisplayed, allowing the teller to mark the disposition of the check. If the teller selected the Change command to make changes, and then, after returning to the identification page selected the Change command again, a warning is first displayed, telling the user that the changes they made in the previous invocation of the Change command will not be shown in the change screen and must be re-entered if they proceed. This gives the user (i.e., the teller) the choice to abandon going to the change credentials page, or proceeding anyway.

The Accept command causes the transaction to be marked as an accepted (i.e., cashed) check. After marking the transaction, the main page 212 is redisplayed. This command is not available if the identification page 214 was entered without a check to be cashed.

The Reject command causes the reject dialog to be displayed, and the result is used to mark the check with the selected rejection reason. After marking the transaction the main page 212 is redisplayed. Preferably, this command is not available if the identification page 214 was entered without a check to be cashed.

The Abandon command provides a shortcut to marking the transaction as an abandoned transaction. After selecting this icon or button, the transaction is marked as abandoned, and the main page 214 is redisplayed.

The OK icon or button preferably only appears if the identification page 214 was entered without a check to be cashed. When the button is selected, the system displays the main page 212. Further, the close button or icon allows the user to close the application if the identification page 214 was entered without a check to cash.

As indicated previously, the enroll page or screen 216 enables a user such as a teller to enroll a customer into the system. The inputs provided on this page include: name, social security number, gender, address, date of birth, drivers license, additional information, and an optional notes filed. In an embodiment, entry of the social security number is not mandatory.

The commands that are available for execution from the enroll page 216 include Next and Cancel. The Cancel command results in the main page 212 being displayed. Further, the Next command causes an enroll dialog 226 to be displayed. If the enroll dialog 226 is cancelled, then the user is returned to the enroll page 216. However, if OK is selected, and the fingerprints are acceptable after being entered as explained in detail further herein, then the person is enrolled in the database. If the enrollment it is a re-enroll (i.e., a duplicate enrollment wherein the name or the social security number is the same), then a message box stating such is displayed. Selecting OK on the message box results in the system displaying the main page 212. If the enrollment is detected as a duplicate enroll, and the name and social security number are different, the already enrolled page 218 is displayed. In either case, a transaction is stored in the database. If the enrollment is successful, a dialog saying so is displayed, and on selecting OK, the main page 212 is displayed.

The already enrolled page or screen 218 provides a warning to a user (i.e., teller) that a person is attempting to enroll a second time in the system. The inputs available on the page 218 are the same as provided in the enroll page. However, they are pre-filled with the values supplied by the enrollee at their first enrollment. Additionally, the fields cannot be edited.

The change credentials page or screen 220 allows a user such as a teller to change a customer's information. The inputs available on this screen include the same set of fields as provided on the enroll page 216. However, the fields on the change credentials screen are pre-filled with the values supplied by the enrollee at their enrollment, or the last value from the last credentials change. Additionally, the notes field may be omitted from this page.

The commands available from the change credentials page include: OK and Cancel. The OK command results in the changes being made to the database. The Cancel command results in the system reverting back to the original transaction list without committing the changes to the server.

The configuration page or screen 222 allows a user to view the configuration of the software. The inputs available on this screen include: Teller ID; Delay Sending Images; and, Message File. The commands available on this screen include: Test; Update; and, Close.

The Teller ID is a standard numeric file that contains the teller identification. If this field is zero, it indicates that the bank does not distinguish between teller stations.

The Delay Sending Images input is a check box that, when checked, causes the software to omit fingerprint image files from transmission to the server. Instead, they are cached in the directory indicated on the configuration page. In an embodiment, a separate program runs the scheduler to upload these files at a later time when more network banding width is available and when a customer is not waiting for a response. The Message File input is a file name text box to access the message file as described in greater further herein.

The test command is an icon or button that, when selected, results in a testing of communication with the configuration server. The results of the test are provided in a message box that indicates whether communication was successful or not.

The Update command causes the software to re-read its configuration from a central website or server. The fields on this page update to reflect the new configuration. Further, the Close command closes the configuration page 222 and returns the user to the main page 212.

The authorization dialog 224 is a dialog that collects a single fingerprint to identify the person. In an embodiment, the dialog will time out if it is left unattended for a time period of, preferably, five minutes. The input to the authorization dialog 224 is the fingerprint read from an external piece of hardware, which can be plugged into a port such as a USB port or other input port. The commands to the authorization dialog 224 include: Start Scanning; Alternative Finger; and, Cancel.

The Start Scanning command causes the reader to start scanning the fingerprint. If the fingerprint is a poor quality image, a dialog indicates so and allows the user to either try again, or cancel, which closes the dialog.

The Alternative Finger command causes the alternative finger dialog 225 to be displayed as described in detail further herein. When the authorization dialog 224 returns, it indicates to the user (i.e., teller) what finger they should scan. Further, the Cancel command closes the authorization dialog 224.

The alternative finger dialog 225 allows a teller to specify which fingers the customer has, should they be missing a right index and right thumb. The teller specifies the situation in the dialog, and then the dialog follows a protocol to decide which finger(s) will be used as a substitute. The input for the alternative finger dialog 225 includes a radio button for each of ten fingers wherein the teller indicates if the finger is intact, damaged, or missing.

The command available from the alternative finger dialog 225 consists of an OK command wherein, by clicking or selecting this command, the dialog goes away and adjusts the calling dialog to specify the correct alternative finger. For the primary (first finger), the calling dialog selects the first of, right index, left index, right middle, left middle, right ring, left ring, right pinkie, and left pinkie. For the second finger, the calling dialog requests the right thumb first, then the first of the preceding list that is not used as a primary identifier, and as a last resort the left thumb is used. In an embodiment, if a person has less than two fingers, then they cannot use the system.

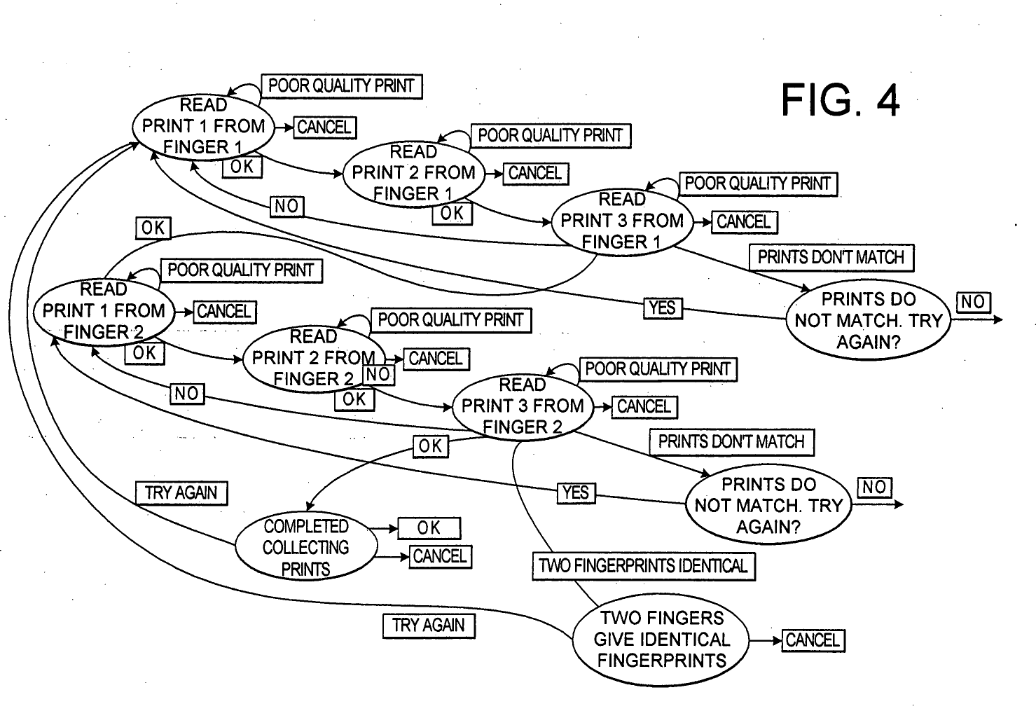

As indicated previously, the enroll dialog 226 allows a user to enroll in the system. The dialog 226 collects three copies of two different fingers and produces an average of each set of three images to obtain a print. The inputs to the enroll dialog 226 are fingerprints read from an external piece of hardware connected to an input port. The commands to the enroll dialog 226 include: Start Scanning; Alternative Finger, and Cancel. The Start Scanning command causes the process of collecting prints to be started. A diagram of the scan process is provided in FIG. 4. The Alternative Finger command causes the alternative finger dialog 225 to be displayed. When it returns it indicates to the user what finger they should scan. Further, the Cancel command closes the dialog.

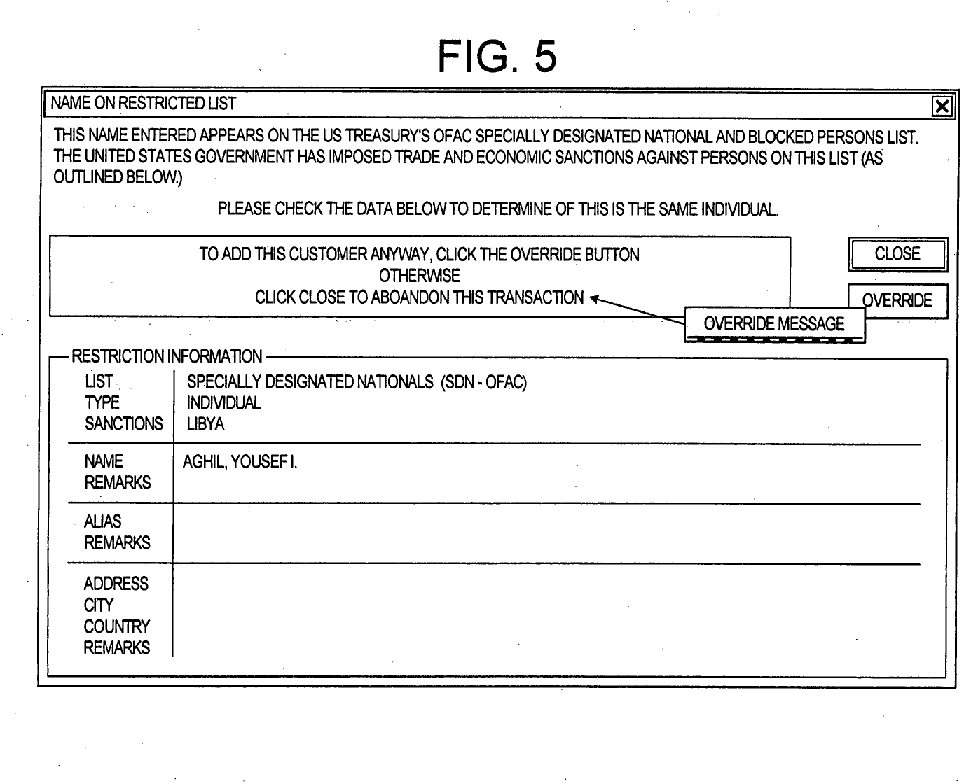

As shown in FIG. 5, the OFAC match dialog displays data from the U.S. Department of the Treasury's OFAC list. The commands on this page include a Close and Override button. In an embodiment, the Close and Override button, along with an override message appear two seconds after the dialog is first displayed. This is to deliberately delay closing the dialog to force the teller to properly consider its disposition. In a further embodiment, if an OFAC match dialog is displayed from the main page OFAC button, then the override button and the override message are not displayed.

The Override command indicates to the calling enroll process that the teller wished to override the automatic OFAC check and continue with the enrollment anyway. It is desired that this process be avoidable since the OFAC check can produce false matches by the nature of the fact that more than one person can have the same name. Further, the Close command closed the OFAC match dialog box.

In an embodiment, the system includes a menu bar. The commands of the menu bar include: Go To Main; Go To Enroll Page; Go To Configuration Screen; Update; About; and, Exit. The Go To Main Page cause the display to revert to the main page 212 whenever this is possible within the application. That is to say, on every screen except preferably the identification screen 214 and the change credentials page 220 because, within these screens, it is desired that the teller indicate the disposition of the check.

The Go To Enroll command results in the user being brought to the enroll page 216 whenever this is possible with the application. That it to say, every screen except preferably the identification screen 214 and the change credentials page 220.

The Go to Configuration Screen command causes the user to go to the configuration screen 222. Preferably, this menu item is only available from the main page 212.

The Update command causes the software to check for a software update at the vendor's server or central server. Preferably, this function is only available from the main page 212.

The About command causes the application to display a box about the software which, preferably, includes the version number and support contact information. Further, the Exit command causes the software to exit. This command is preferably available everywhere except the identification screen 214 since the teller must indicate the disposition of the check.

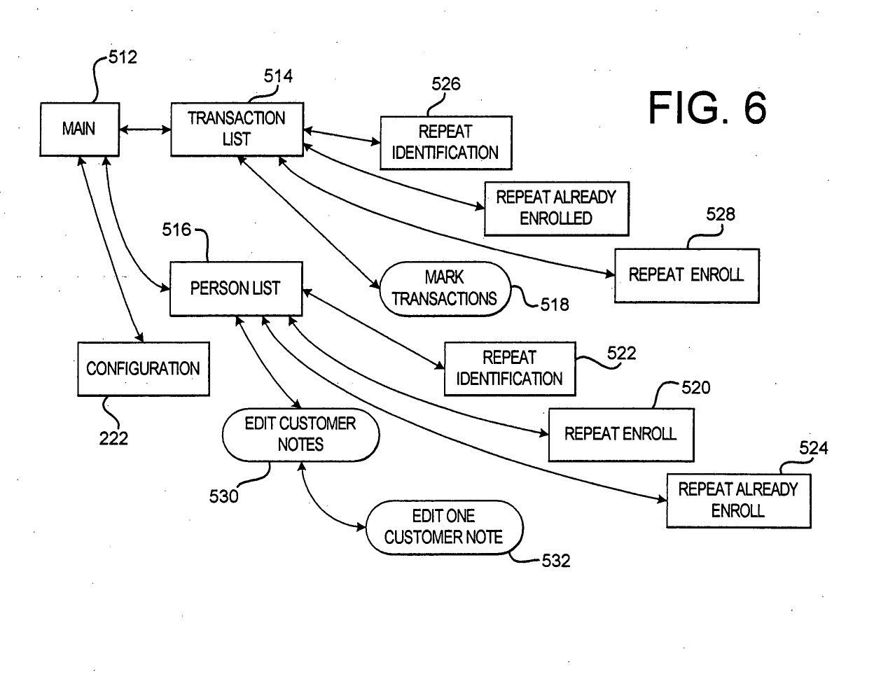

A map of the back office screens, or pages, is provided in FIG. 6. The back office screens include a main page 512 that allows the user to mark transactions and customers. The inputs to the main page 512 include Date and Last Name. The Date specifies the date and time range of the transaction the user wishes to view. Further, the last name specifies the last name of the person which the user wants to display.

The commands to the main page include: Find Transactions and Find Customers. The Find Transactions command causes the program to go to the Transaction List page or screen 514 that lists the transactions that occurred in the bank during the time range specified in the main page 512. The Find Customers command causes the program to go to the customer list page 516 that lists the customers with the corresponding last name who have done business at that bank.

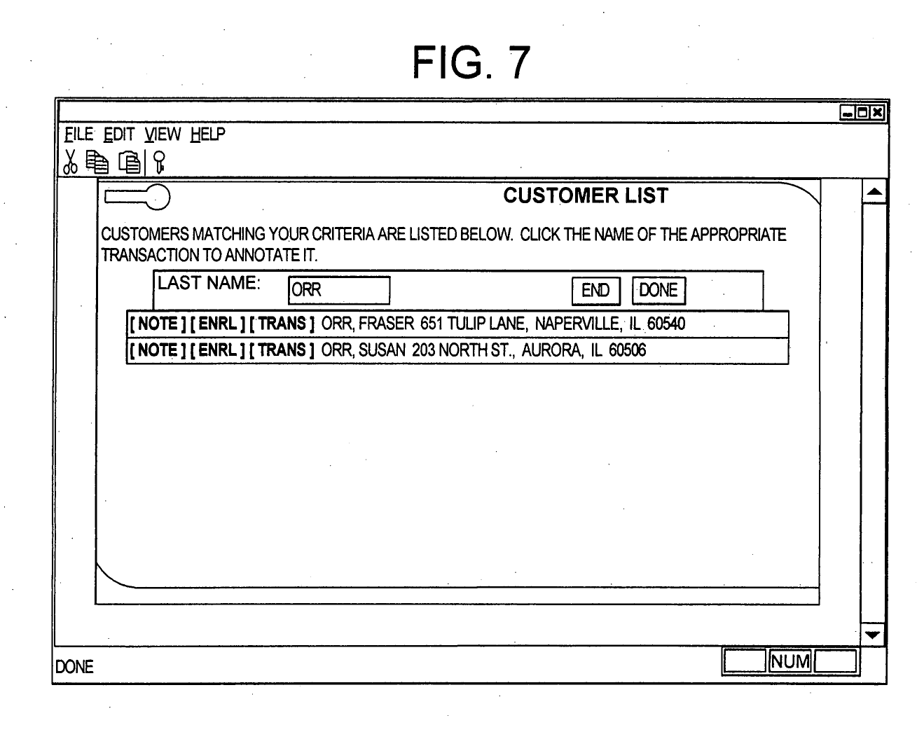

As stated previously, the transaction list page 514 lists all the transactions that have been conducted by the bank during the specified time period. The page also allows the user to look at more details on each transaction. Preferably, as shown in FIG. 7, the transactions are listed in the same format as shown on the identification page 214 (FIG. 2) except that transactions are listed strictly in ascending order for time. Additionally, each transaction is preceded by three hyperlinks which are described in greater detail further herein.

The inputs to the transaction list page consist of the date and time range for the transactions to list. The commands to the transaction list page include: Refresh; Done; Note; Cust; and, View. The Refresh command causes the software to redisplay the page using the criteria specified in the inputs section. Further, the Done command returns the user to the main page 512.

The Note command is a hyperlink next to each transaction. Selecting the hyperlink brings up the mark transactions dialog 518. If OK is selected on the dialog, the transaction annotation selected in the dialog is set as the transaction annotation. This appears preferably in the transaction list at the end of the transaction line. In an embodiment, only check cashing transactions can be annotated. Enroll type transaction also show the hyperlink for consistency, however, clicking on such a hyperlink simply brings up a message box warning of this situation.

The Cust command is a hyperlink next to each transaction wherein selecting the hyperlink results in the user being brought to the repeat enroll page 520 with the enroll criteria entered for the customer who performed the selected transaction.

The View command is a hyperlink next to each transaction. Selecting the hyperlink results in the user being directed to a different screen depending on the type of transaction. If the transaction is a regular check cashing transaction, a copy of the identification screen 214 (FIG. 2) that was shown to the teller before that transaction was cashed is shown. This is shown on the repeat identification page 522. This allows the back office staff to see what information the teller had before cashing the check.

If the transaction is an enrollment, then a copy of the original enrollment data as shown in the repeat enrollment page 520 is provided by the View command. If the transaction is a re-enrollment, then a message is displayed indicating such and the date supplied for re-enrollment is shown on the repeat enrollment page 520. If the transaction is a duplicate enrollment, then the duplicate enrollment information is shown in the repeat already enrollment page 524.

The repeat identification page or screen 526 provides a copy of the information a teller was shown before they disposed of a transaction. In a situation where a transaction proved to be fraudulent, this allows the bank management to dig into the transaction and see exactly what data the teller used to determine to cash the check.

The commands for the repeat identification page include Show Alerts wherein the command causes a repeat of the alerts shown when the page was first displayed. As such, any cancelable alerts will be shown as they were originally. However, any attempt to cancel the alert is met with an appropriate warning.

The repeat enroll page or screen 528 consists of an enroll screen for the selected user (i.e., customer). The data shown is the data that was entered at enroll. Any subsequence changes via the change credentials or modification of the notes on this person are not reflected on this screen. This is deliberate so that the exact data on the enroll can be seen. Likewise, the repeat already enrolled page provides a copy of the duplicate enrollment page as it was shown to the teller.

The customer list page 516 lists all the customers in the primary or central server data base that have done business with this bank whose last name matched the one specified in an input box. As shown in FIG. 7, each customer is listed with the last name followed by the first name, followed by their current registered address in small type. Next to each transaction are three hyperlinks as described further herein.

The input to the customer list page consists of a last name field wherein the user can change the last name to search for. The commands to the customer list page include: Find; Done; Note; Enrl; and, Trans. The Find command refreshes the list by requerying the command at the database. Any changes made by other back office software users, or any additional matching names, or any changes in credentials are reflected by selecting the Find command.

The Done command results in the user being brought back to the back office main page 512. The Note command includes a hyperlink next to each customer that pulls up the edit customer notes dialog 530 on that customer. The Enrl command results in a display of the repeat enroll page 520 for the selected customer. The Trans command results in a transaction list for each customer being provided as if a non-check cashing identification had been applied, and thus shows the information in the repeat identification page 522 as previously described above.

As indicated previously, the mark transaction dialog 518 allows the user to add back office annotations to a transaction. This can be used when a batch of bad checks come into the bank back office. The bank can then indicate the problems associated with the checks, so that the information is available in subsequent identifications.

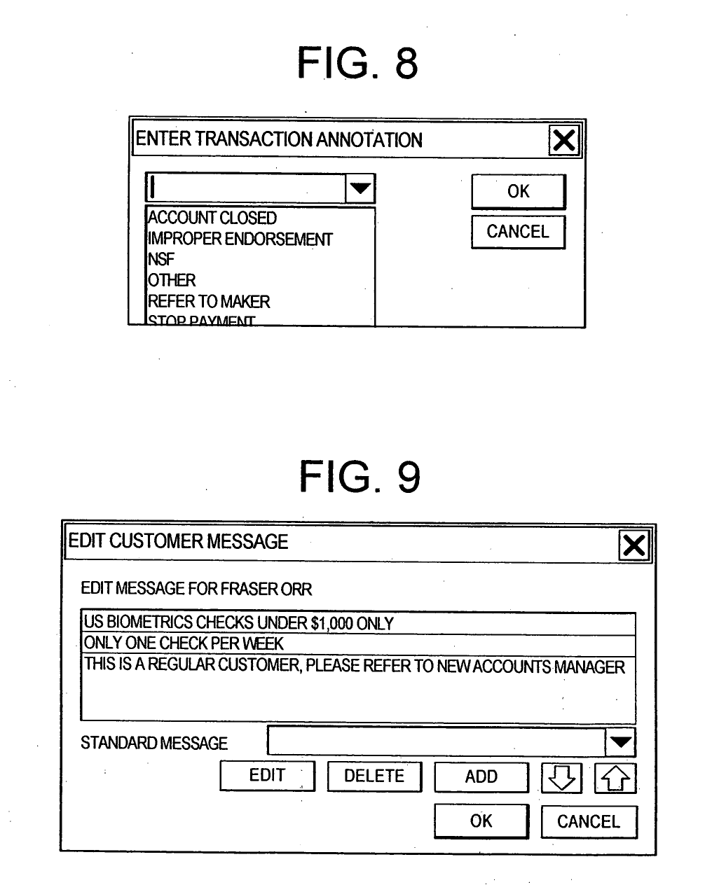

The input to the mark transaction dialog 518, as shown in FIG. 8, includes a combo box to select the transaction annotation. The commands to the mark transaction dialog box include OK and Cancel. The OK command marks the transaction with the given annotation (i.e., annotation entered by the user). Preferably, this annotation subsequently appears in any identification screen showing this check. The priority and severity of the display, as well as the allowable annotation are described in greater detail further herein. Moreover, the Cancel command results in the dialog being canceled and does not annotate the transaction.

As shown in FIG. 9, the edit customer notes dialog 530 allows the back office staff to add notes for association with a particular customer. The dialog includes a list with a one line summary for each note. The commands for this dialog include Add, Edit, Delete, Move Up and Move Down, OK, and Cancel.

The Add command results in a message or note being added and thus opens the edit one customer note dialog 532 to allow the user to edit it. The Edit command results in the edit one customer note dialog being opened for the selected note or message. The Delete command results in the selected note or message being deleted after a confirm message is displayed. The Move Up and Move Down commands consist of arrow buttons or icons that move the selected message or note up or down in the order of display. Moving the note or message effects both the order that the note or message is shown in the identification page 214 (i.e., the portion below the name and address), and also the order that any pop up boxes are shown to the user (i.e., teller) in the identification page. The OK command closes the dialog and saves the changes to the messages or notes that were entered. Further, the Cancel command closes the dialog and cancels any changes that might have been made.

In an embodiment, the command buttons or icons are enabled and disabled according to a scheme. In particular, the Add, OK, and Cancel commands are always enabled. Further, the Edit command is enabled whenever a message or note is selected in the list. Further, the Move Up and Move Down commands are enabled when an item is selected in the list, except that the up arrow is not enabled when the first item is selected, and the down arrow is not enabled when the last item is selected.

Turning to the edit one customer note dialog 532, this allows the user to edit one customer message or, in the case of an Add command, add the text of a new message. The inputs to this dialog allow for a user to edit a message or note in a conventional matter. A combo box is provided that allows the user to choose the type of message such as: Normal permanent message; Pop up permanent message; and Pop up till teller clears. The Normal permanent message causes the system to provide the message in the notes area on the identification page 214. The Pop up permanent message will cause the message to appear in the notes area and also pop-up as a dialog box, with an OK button, when the identification page is displayed. The Pop up till teller clears allows the message to appear in the notes area and also as a pop up as with the pop up permanent message. However, in this case the dialog has both an OK and a Cancel button wherein if the user selected the cancel after a confirmation, the teller can delete this pop up message from the identification screen.

The back office menu bar provides Commands that include: Go To Configuration Screen; Update; About; and Exit. The Go To Configuration Screen command causes the system to take the user to the configuration screen 222. Preferably, this menu item is only available from the main page 512. The Update command causes the software to check for a software update at a central server. The About command results in the system displaying a box about the software that includes the version number and support contact information. Further, the Exit command causes the software to exit.

In an embodiment, a bank is allowed to specify a standard message file. This allows the bank's back office staff and tellers to enter consistent messages for customers. The format of a standard message file is a regular text file, with each message on a separate line. Additionally, in an embodiment, the first character of each line is a special code letter as follows:

1. An “A” indicates that the message is a regular message that appears until the back office staff removes it.

2. A “P” indicates that the message should pop up to the teller to five them high priority information about this individual.

3. A “C” indicates that the message should pop up to the teller to give them high priority information about the individual. However, when the teller clicks cancel, the message is permanently removed from the person's record. This allows the back office staff to put in temporary messages for individual customers.

As indicated previously, fingerprints are matched according to certain rules. Preferably, in an embodiment, these rules are different for identification and enrollment. During identification, a fingerprint is compared against only those fingerprints matching individuals with a similar last name to that given on the main page 212. This heuristic enables a faster identification. In an embodiment, the system compensates for common phonetically based misspelling of last names, such as, for example, D'Arcy rather than Darcy, or Allison rather than Alison, and Smythe instead of Smith. This is accomplished by using a list of related name spellings or fuzzy logic. However, should someone use a false name, then a successfully match will not occur during identification. This is not a risk to security since the person will not be allowed to access the system until they enroll.

In an embodiment, during enrollment, the fingerprint is checked against every fingerprint in the database to search for a match. This methodology prevents someone from re-enrolling under a false name.

It is noted that in rare cases two fingerprints are too similar to distinguish between them. In such cases the secondary identifier comprising the thumbprint is used to distinguish between candidates with matching fingerprints. As such, the system instructs the teller to collect the additional fingerprint.

In an embodiment, checks can have two disposition markers, one disposition given by the teller at the time of the transaction, and the second given in the bank's back office should the check be returned for insufficient funds or other reasons. Preferably, dispositions are rated as to the level of seriousness between 0 (i.e., benign) to 9 (i.e., very serious). A preferred embodiment of the classes of disposition are provided below for tellers and the back office:

| Teller Dispositions | Disposition Rating |
|---|---|
| Abandoned | 1 |
| Account Overdrawn | 1 |
| Altered Check | 4 |
| Appears Counterfeit | 4 |
| Check Larger Than Allowed | 1 |
| Closed Account | 1 |
| Deceptive Customer | 4 |
| Does Not Make Sense | 1 |
| Forgery Suspected | 4 |
| Maker Has Hold On Account | 1 |
| Non-Endorsable Item | 1 |
| Notes Indicate Problem | 4 |
| Not Sufficient Funds In Account | 1 |
| Other | 1 |
| Scam Suspected | 4 |
| Stale Dated Check | 1 |
| Stolen Check | 4 |
| Transaction History Bad | 4 |
| Unable To Reach Maker | 1 |
| Unable To Verify Funds | 1 |

| Back Office Dispositions | Disposition Rating |
|---|---|
| Refer To Maker | 6 |
| Not Sufficient Funds | 1 |
| Uncollected Funds | 6 |
| Account Closed | 2 |
| Stop Payment | 6 |
| Bad Endorsement | 9 |
| Other | 1 |

With the above dispositions, the following is a preferred manner of displaying each disposition level in the identification screen 214:

| Disposition Rating | Manner of Displaying |
|---|---|
| 0 | No Highlighting |
| 1-3 | Highlight Text In Blue |
| 4-6 | Highlight Text In Red And Bold |
| 7-9 | Highlight In Red And Bold, And In |
| | Popup Dialog To Teller |

While the specific embodiments have been illustrated and described, numerous modifications come to mind without significantly departing from the spirit of the invention and the scope of protection is only limited by the scope of the accompanying claims.

I claim:

1. A method for verifying an individual's identity, the method comprising the steps of:
a. receiving at least one biometric identifier from an individual;
b. comparing the at least one biometric identifier to biometric identifiers contained in a database;
c. associating the at least one biometric identifier from the individual with an individual identity contained in a central database; and,
d. outputting information associated with the individual from the central database.

2. The method of claim 1 wherein the at least one biometric identifier is selected from the group comprising fingerprints, palm prints, facial images, retinal images, and voice prints.

3. The method of claim 1 further comprising the steps of:
i. identifying the zip code of the location wherein the at least one biometric identifier from an individual was received; and,
ii. creating a smaller database of biometric identifiers previously received from surrounding zip codes to compare to the at least one biometric identifier from an individual.

4. The method of claim 1 further comprising the steps of:
i. identifying a tag for the individual; and,
ii. creating a smaller database of biometric identifiers previously received from individuals that have the same tag to compare to the at least one biometric identifier from an individual.

5. The method of claim 4 wherein the tag is selected from the group comprising birth dates, phone numbers, last names, and Metaphone encoded last names.

6. A method for verifying a customer's identity, the method comprising the steps of:
a. receiving at least one biometric identifier from an individual;
b. comparing the at least one biometric identifier to biometric identifiers contained in a database;
c. associating the at least one biometric identifier from the individual with a customer identity contained in a local database;
d. transmitting the customer identity to a central database; and,
e. outputting information associated with the individual from the central database.

7. The method of claim 6 wherein the at least one biometric identifier is selected from the group comprising fingerprints, palm prints, facial images, retinal images, and voice prints.

8. The method of claim 6 further comprising the steps of:
i. identifying the zip code of the location wherein the at least one biometric identifier from an individual was received; and,
ii. creating a smaller database of biometric identifiers previously received from surrounding zip codes to compare to the at least one biometric identifier from an individual.

9. The method of claim 6 further comprising the steps of:
i. identifying a tag for the individual; and,
ii. creating a smaller database of biometric identifiers previously received from identifiable individuals that have the same tag to compare to the at least one biometric identifier from an individual.

10. The method of claim 9 wherein the tag is selected from the group comprising birth dates, phone numbers, last names, and Metaphone encoded last names.

11. The method of claim 6 further comprising the step of updating the local database new data from the central database.

12. A method for verifying a customer's identity, the method comprising the steps of:
a. transmitting at least one biometric identifier from a remote location to a central server;
b. comparing the at least one biometric identifier to biometric identifiers contained in a database;
c. associating the at least one biometric identifier from the remote location with a customer identity contained in a central database; and,
d. outputting information associated with the individual from the central database.

13. The method of claim 12 wherein the at least one data field is a data field shared by the remote location.

14. The method of claim 12 wherein the at least one biometric identifier is selected from the group comprising fingerprints, palm prints, facial images, retinal images, and voice prints.

15. The method of claim 12 further comprising the steps of:
i. identifying the zip code of the location wherein the at least one biometric identifier from an individual was received; and,
ii. creating a smaller database of biometric identifiers previously received from surrounding zip codes to compare to the at least one biometric identifier from an individual.

16. The method of claim 12 further comprising the steps of:
i. identifying a tag for the individual; and,
ii. creating a smaller database of biometric identifiers previously received from identifiable individuals that have the same tag to compare to the at least one biometric identifier from an individual.

17. The method of claim 16 wherein the tag is selected from the group comprising birth dates, phone numbers, last names, and Metaphone encoded last names.

18. A system for verifying a customer's identity, the system comprising:
a. a first component for receiving at least one biometric identifier from an individual;
b. a second component for comparing the at least one biometric identifier to biometric identifiers contained in a database;
c. a third component for associating the at least one biometric identifier from the individual with a customer identity contained in a central database; and,
d. a fourth component for outputting information associated with the individual from the central database.

19. The system of claim 18 wherein the at least one biometric identifier is selected from the group comprising fingerprints, palm prints, facial images, retinal images, and voice prints.

20. The system of claim 18 further comprising a fifth component for identifying the zip code of the location wherein the at least one biometric identifier from an individual was received and a sixth component for creating a smaller database of biometric identifiers previously received from surrounding zip codes to compare to the at least one biometric identifier from an individual.

21. The system of claim 18 further comprising a fifth component for identifying a tag for the individual and a sixth component for creating a smaller database of biometric identifiers previously received from identifiable individuals that have the same tag to compare to the at least one biometric identifier from an individual.

22. The system of claim 21 wherein the tag is selected from the group comprising birth dates, phone numbers, last names, and Metaphone encoded last names.

23. A system for verifying a customer's identity, the system comprising:
a. a first component for receiving at least one biometric identifier from an individual;
b. a second component for comparing the at least one biometric identifier to biometric identifiers contained in a database;
c. a third component for associating the at least one biometric identifier from the individual with a customer identity contained in a local database;
d. a fourth component for transmitting the customer identity to a central database; and,
e. a fifth component for outputting information associated with the individual from the central database.

24. The system of claim 23 wherein the at least one biometric identifier is selected from the group comprising fingerprints, palm prints, facial images, retinal images, and voice prints.

25. The system of claim 23 further comprising a sixth component for identifying the zip code of the location wherein the at least one biometric identifier from an individual was received and a seventh component for creating a smaller database of biometric identifiers previously received from surrounding zip codes to compare to the at least one biometric identifier from an individual.

26. The system of claim 23 further comprising a sixth component for identifying a tag for the individual and a seventh component for creating a smaller database of biometric identifiers previously received from identifiable individuals that have the same tag to compare to the at least one biometric identifier from an individual.

27. The system of claim 26 wherein the tag is selected from the group comprising birth dates, phone numbers, last names, and Metaphone encoded last names.

28. The system of claim 23 further comprising a sixth component for updating the local database new data from the central database.

29. A system for verifying a customer's identity, the system comprising:
a. a first component for transmitting at least one biometric identifier from a remote client to a central server;
b. a second component for comparing the at least one biometric identifier to biometric identifiers contained in a database;
c. a third component for associating the at least one biometric identifier from the remote client with a customer identity contained in a central database; and,
d. a fourth component for outputting information associated with the individual from the central database.

30. The system of claim 29 wherein the at least one data field is a data field shared by the remote client.

31. The system of claim 29 wherein the at least one biometric identifier is selected from the group comprising fingerprints, palm prints, facial images, retinal images, and voice prints.

32. The system of claim 29 further comprising a fifth component for identifying the zip code of the location wherein the at least one biometric identifier from an individual was received and a sixth component for creating a smaller database of biometric identifiers previously received from surrounding zip codes to compare to the at least one biometric identifier from an individual.

33. The system of claim 29 further comprising a fifth component for identifying a tag for the individual and a sixth component for creating a smaller database of biometric identifiers previously received from identifiable individuals that have the same tag to compare to the at least one biometric identifier from an individual.

34. The system of claim 33 wherein the tag is selected from the group comprising birth dates, phone numbers, last names, and Metaphone encoded last names.

35. A computer program product for verifying a customer's identity, the computer program product comprising:
a. a first code segment for receiving at least one biometric identifier from an individual;
b. a second code segment for comparing the at least one biometric identifier to biometric identifiers contained in a database;
c. a third code segment for associating the at least one biometric identifier from the individual with a customer identity contained in a central database; and,
d. a fourth code segment for outputting information associated with the individual from the central database.

36. The computer program product of claim 35 wherein the at least one biometric identifier is selected from the group comprising fingerprints, palm prints, facial images, retinal images, and voice prints.

37. The computer program product of claim 35 further comprising fifth code segment for identifying the zip code of the location wherein the at least one biometric identifier from an individual was received and a sixth code segment for creating a smaller database of biometric identifiers previously received from surrounding zip codes to compare to the at least one biometric identifier from an individual.

38. The computer program product of claim 35 further comprising a fifth code segment for identifying a tag for the individual and a sixth component for creating a smaller database of biometric identifiers previously received from identifiable individuals that have the same tag to compare to the at least one biometric identifier from an individual.

39. The computer program product claim 38 wherein the tag is selected from the group comprising birth dates, phone numbers, last names, and Metaphone encoded last names.

40. A computer program product for verifying a customer's identity, the computer program product comprising:
a. a first code segment for receiving at least one biometric identifier from an individual;
b. a second code segment for comparing the at least one biometric identifier to biometric identifiers contained in a database;
c. a third code segment for associating the at least one biometric identifier from the individual with a customer identity contained in a local database;
d. a fourth code segment for transmitting the customer identity to a central database; and,
e. a fifth code segment for outputting information associated with the individual from the central database.

41. The computer program product of claim 40 wherein the at least one biometric identifier is selected from the group comprising fingerprints, palm prints, facial images, retinal images, and voice prints.

42. The computer program product of claim 40 further comprising sixth code segment for identifying the zip code of the location wherein the at least one biometric identifier from an individual was received and a seventh code segment for creating a smaller database of biometric identifiers previously received from surrounding zip codes to compare to the at least one biometric identifier from an individual.

43. The computer program of claim 40 further comprising a sixth code segment for identifying a tag for the individual and a seventh component for creating a smaller database of biometric identifiers previously received from identifiable individuals that have the same tag to compare to the at least one biometric identifier from an individual.

44. The computer program product of claim 43 wherein the tag is selected from the group comprising birth dates, phone numbers, last names, and Metaphone encoded last names.

45. The computer program product of claim 40 further comprising a sixth code segment for updating the local database new data from the central database.

46. A computer program product for verifying a customer's identity, the computer program product comprising:
a. a first code segment for transmitting at least one biometric identifier from a remote location to a central server;
b. a second code segment for comparing the at least one biometric identifier to biometric identifiers contained in a database;
c. a third code segment for associating the at least one biometric identifier from the remote location with a customer identity contained in a central database; and,
d. a fourth code segment for outputting information associated with the individual from the central database.

47. The computer program product of claim 46 wherein the at least one data field is a data field shared by the remote location.

48. The computer program product of claim 46 wherein the at least one biometric identifier is selected from the group comprising fingerprints, palm prints, facial images, retinal images, and voice prints.

49. The computer program product of claim 46 further comprising fifth code segment for identifying the zip code of the location wherein the at least one biometric identifier from an individual was received and a sixth code segment for creating a smaller database of biometric identifiers previously received from surrounding zip codes to compare to the at least one biometric identifier from an individual.

50. The computer program of claim 46 further comprising a fifth code segment for identifying a tag for the individual and a sixth component for creating a smaller database of biometric identifiers previously received from identifiable individuals that have the same tag to compare to the at least one biometric identifier from an individual.

51. The computer program product of claim 50 wherein the tag is selected from the group comprising birth dates, phone numbers, last names, and Metaphone encoded last names.
